(19) United States
(12) Patent Application Publication
(10) Pub. No.: US 2009/0071587 A1
(43) Pub. Date: Mar. 19, 2009

(54) TIRE CORD FABRIC

(76) Inventors: Kenneth Dean Conger, Stow, OH (US); Kenneth Michael Kot, Canton, OH (US); Jon Michael Madaras, Fairlawn, OH (US); Paul Michael Bujak, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/855,253

(22) Filed: Sep. 14, 2007

(51) Int. Cl. B60C 9/00

(52) U.S. Cl. 152/556

(57) ABSTRACT

An improved tire cord fabric is provided that has a main portion and a tabby. The tire cord fabric is comprised of warp cords oriented in the longitudinal direction and weft yarns oriented in the lateral direction. The warp cords are used in reinforcing pneumatic tires. In the tabby, the weft yarns have an increased count per inch versus the count per inch of the weft yarns in the main portion of the fabric. The weft yarns in the tabby are preshrunk prior to weaving of the tire cord fabric.

### FIELD OF THE INVENTION

The present invention is directed to a tire cord fabric. More particularly, the present invention is directed to a method of manufacturing tire fabric and the type of yarn used in the end, or tabby portions, of the tire cord fabric.

### BACKGROUND OF THE INVENTION

Fabric used in the reinforcing of tires is normally comprised of tire cords placed in the warp or longitudinal direction of the fabric, with the warp tire cords being woven or held by a relatively weak weft yarn oriented perpendicular to the cords. The number of tire cords per inch in tire cord fabrics normally varies depending on the end uses and the tire specification. The number of weft yarns per inch also varies.

The weft yarns serve the purposes of maintaining the structural integrity of the fabric during further fabric treatment and maintaining the desired spacing between the warp tire cords during building and expansion of the green tire.

It is a common practice to treat tire reinforcing fabric with liquid adhesives. This treatment is to improve the adhesion between the fabric and the rubber matrix of the tire. The untreated fabric is normally wound into a roll. As the last piece of fabric leaves the roll and before it enters the dip unit, the tail end of the roll is attached to the first end of the next roll to be treated. Where the ends of the rolls are to be attached together, the count per inch of the weft yarn is increased at the end of the roll to contribute to the strength of the splice or seam. This increased count per inch weft yarn area of the fabric is known as the tabby and normally measures in length between 5 and 20 inches. The tabby is not used in reinforcing tires and is discarded as waste at some point in the rubber calendering operation.

Because of the closeness of the weft yarns to one another in the tabby section of the fabric, there is an increased crimping of the weft yarns by the warp cord, which is held under tension during the weaving. This leads to a narrowing of the fabric width to accommodate the increased count per inch of weft yarn, transforming the ends of the fabric from a relatively straight configuration to a wavy or crimped configuration. Additionally, during heat treatment of the fabric, shrinkage of the weft yarns can cause the tabby to further contract, see FIG. 2. The narrowing of the tabby can result in wrinkling of the fabric and inconsistent dipping of the fabric during treatment.

While it has been accepted that the tabby portion is discarded as waste during calendering, due to the narrowing of the tabby fabric during conventional treatment, a portion of the regular tire cord fabric is also reduced in width, FIG. 2, and is discarded along with the tabby area, resulting in increased waste. Also, this narrowing of the tabby results in disturbances in the process, especially with the fabric spreading and guiding equipment. These disturbances result in waste due to poor warp cord quality near the tabby, poor wind-up quality, fabric web splits, etc.

### SUMMARY OF THE INVENTION

The present invention is directed to a method of producing tire cord fabric having an improved structure for the tabby wherein width reduction of the tabby and the adjacent fabric portion are reduced, thereby reducing waste and improving fabric treatment consistency.

### BRIEF DESCRIPTION OF THE DRAWINGS

The invention will be described by way of example and with reference to the accompanying drawings in which:

FIG. 1 illustrates a tire cord fabric; and

FIG. 2 illustrates a prior art tire cord fabric after treatment.

### DETAILED DESCRIPTION OF THE INVENTION

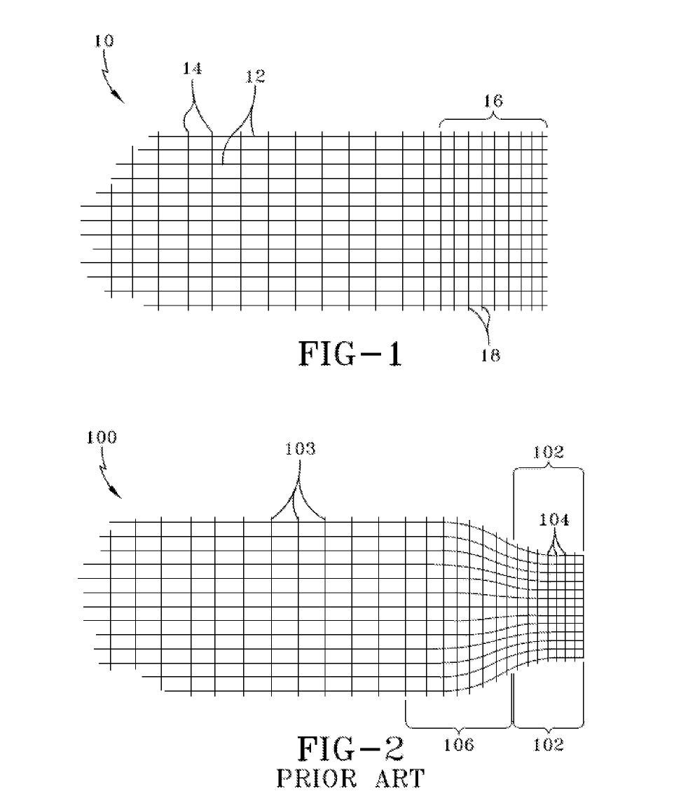

In FIG. 1, a fabric 10 is illustrated. The fabric 10 is formed of a plurality of warp cords 12 and weft yarns 14. In the main portion of the fabric 10, comprising about 99% of the length of the fabric 10, the weft yarns 14 are generously spaced from one another at a count per inch of about 0.5 to 3 per inch (1.3 to 7.6 per cm). At the terminal end of the fabric 10, the density of the weft yarns 14 is increased to form the tabby 16.

The warp cords 12 are tire cords and may be formed from any materials used for tire cords, including, but not limited to, steel, carbon fiber, aramid, nylon, rayon, polyester, fiberglass, polyvinyl alcohol, or any blends thereof, or other future types of tire cords. The exact cord specifications and the spacing of the warp cords are determined by the tire specification.

As the weft yarns 14 function primarily to maintain the spacing of the warp cords 12 in the main portion of the fabric 10, the diameter, denier, and/or strength of the weft yarns 14 need not be equal to that of the warp cords 12. The weft yarns 14 are generally selected from any suitable material having a breaking strength of from about 1.5 to about 4 pounds (0.68 to 1.81 kg), and an elongation at break of from about 20 to about 45 percent. The size of the weft yarn 14 depends on the corresponding size of the metal warp cord. The weft yarns 14 are generally selected from lightweight materials such as polyester, cotton, rayon, nylon, or blends thereof.

In the tabby 16, to provide strength assistance in the splice or seam when joining fabric rolls/lengths, the weft yarns 18 of the tabby 16 may be different than the weft yarns 14 in the main portion of the fabric 10. The tabby weft yarns 18 may be selected from the same material, with an increased denier to provide a denser, stronger yarn, or may be selected from an entirely different material with different yarn specifications.

In a conventional fabric 100, when the fabric 100 is treated, as discussed above, the tabby 102 is reduced in lateral width due to shrinkage and crimping of the tabby weft yarns 104. However, the width reduction is not limited to the tabby 102 and a portion 106 of the fabric 100 also has reduced lateral width and this portion 106 of the fabric 100 is generally relegated to waste material. While FIG. 2 is purely illustrative of the lateral shrinkage, the fabric 100 has an approximately 37.5% loss in width due to shrinkage and at least a 10% loss in width is conventional.

In accordance with the goal of the present invention—to reduce the lateral width shrinkage of the tabby 16 as the fabric 10 is treated, the tabby weft yarns 18 are selected for reduced shrinkage. Any conventional tabby weft yarn may be used; however, the yarn, prior to being woven into the tabby 16, must be preshrunk. Preshrunk means that the yarn is processed by treatment so that its length is not reduced by more than 1 to 10 percent, more particularly, by 1 to 3 percent. Preferably, the yarn is preshrunk so that its length is not reduced by more than 1% during fabric treatment. Specific preshrinking treatment will be dependent upon the type of yarn, but may comprise for example, a two zone process. In the first zone, the material may be over stretched at a tension ranging from about 10% to about 25% of the greige cord's breaking strength. In the second zone, the material may be relaxed wherein the tension is less than 5% of the greige cord breaking strength. The temperatures for both zones may be in the range of about 90% to about 97% of the material's melting point. For a cotton weft yarn, preshrinking typically may include exposure to high heat in a humid condition such as a hot water bath and drying.

Conventionally, both weft 14 and tabby weft 18 yarns are not preshrunk prior to use in tire cord weaving operations. Instead, yarn is used directly from the yarn manufacturer, and all treatment of the yarns 14, 18 occurs with the treatment of the fabric. By using preshrunk yarn as the tabby weft 18, the width reduction in the tabby 16 is reduced and any portion of the fabric 10 that is also reduced due to the tabby width reduction is minimized, thereby reducing waste and improving adhesive treatment of the fabric. There may continue to be a loss of width in the tabby 16 due to crimping; however, this loss should be limited to less than 5% of the fabric width; the tabby 16 should have a width of at least 95% of the width of the main fabric portion.

The tabby weft yarns 18 of the present invention can be used in the body of the fabric, as well as the tabby 16. Where the body of fabric is subject to severe thermal shrinkage conditions and mechanical tensioning such that the combination of factors results in unreasonable width reduction in the body of the fabric 10, the use of the tabby weft yarn 18 of the present invention in the body of the fabric is beneficial.

What is claimed is:

1. A tire cord fabric, the tire cord fabric having a longitudinal direction and a lateral direction and a main portion and a tabby, the tire cord fabric comprising warp cords oriented in the longitudinal direction and weft yarns oriented in the lateral direction, the warp cords being tire cords useful in the reinforcing of pneumatic tires, wherein in the tabby the weft yarns have an increased count per inch versus the count per inch of the weft yarns in the main portion of the fabric, and wherein the weft yarns in the tabby are preshrunk prior to weaving of the tire cord fabric.

2. The tire cord fabric of claim 1 wherein the preshrunk weft yarns have a remaining shrinkage of not more than 1% of the length of the weft yarn.

3. The tire cord fabric of claim 1 wherein the tabby has a reduced lateral width in comparison to the fabric main portion, the tabby having a width of at least 99% of the width of the fabric main portion.

4. The tire cord fabric of claim 1 wherein the fabric is adhesively treated.

5. The tire cord fabric of claim 1 wherein the weft yarns in the fabric main portion are also preshrunk.

6. The tire cord fabric of claim 1 wherein the material of the preshrunk weft yarns is selected from the group consisting of polyester, cotton, rayon, nylon, or blends thereof.
